(19) United States
(12) Patent Application Publication
(10) Pub. No.: US 2019/0164145 A1
(43) Pub. Date: May 30, 2019

(54) PREAUTHORIZATION OF TRANSACTION PAYMENT ON A MOBILE DEVICE

(71) Applicant: MasterCard International Incorporated, Purchase, NY (US)

(72) Inventors: Tanika Gupta, Gurgaon (IN); Shoorvir Gupta, Banka (IN); Anshul Pandey, White Plains, NY (US)

(21) Appl. No.: 15/822,759

(22) Filed: Nov. 27, 2017

(51) Int. Cl. G06Q 20/32; G06Q 20/40; G06Q 20/20; G06Q 20/36; G06Q 30/06; H04W 4/02

(52) U.S. Cl. CPC G06Q 20/3224; G06Q 20/40; H04W 4/021; G06Q 20/36; G06Q 30/06; G06Q 20/20

(57) ABSTRACT

A positional-based transaction payment preauthorization system includes an electronic payment processing center (EPPC) communicating with a mobile computing device (MCD) associated with at least one payment card account (PCA), a data store containing merchant physical location information records, the EPPC configured to acquire positional information of the MCD, access the merchant location records, compare the mobile computing device positional information with the merchant location records, identify whether at least one merchant has a location within a predefined distance of the MCD, if at least one merchant is identified, then calculate a spend propensity prediction for the at least one PCA, provide to an issuer bank of the at least one PCA the identified merchant and the spend prediction, receive from the issuer bank a preauthorization associated with a respective one of the at least one PCA, and provide the preauthorization to the MCD. A method and computer-readable medium are disclosed.

### BACKGROUND

Portable electronic devices, such as smartphones, tablet computers, digital music players and the like, have been developed that include desirable functionality and thus the number of mobile device users and/or owners keeps growing. Such mobile devices can store all types of information, and can perform many different types of functions for users. The overall popularity of such mobile devices, especially smartphones, has led to the development of processes for using them to conduct financial transactions, for example, transmission of a payment between a payer (a consumer or payment card account holder or cardholder) and a recipient (or payee, such as a merchant or another cardholder).

Masterpass™ is a global digital payments service offered by Mastercard International Incorporated that enables consumers to look no further than their own trusted bank to make fast, seamless and secure digital payments across devices and channels anywhere they want to shop. Masterpass™ can be used as a companion payment application to a mobile banking app, as a separate bank-branded payment app using the Masterpass™ payment capabilities, or can be embedded within the mobile banking app. In addition, there are other Masterpass™ supported wallets including Masterpass™ by Mastercard (direct wallet), and dual account cards that support Masterpass™ (X-Pay wallets, such as Apple Pay™, Samsung Pay™, and Android Pay™). Thus, consumers can shop online, in app and with a contactless tap at millions of locations around the world by using their mobile devices, as Masterpass™ is designed to support and integrate into any smart device across operating systems and manufacturers. Masterpass™ utilizes a combination of bank verification, card tokenization and Europay/Mastercard/, Visa-like capability to deliver greater security across payment channels.

### BRIEF DESCRIPTION OF THE DRAWINGS

Features and advantages of some embodiments of the present disclosure, and the way such embodiments are accomplished, will become more readily apparent upon consideration of the following detailed description taken in conjunction with the accompanying drawings, which illustrate exemplary implementations and are not necessarily drawn to scale, wherein:

FIG. 1 depicts a system for preauthorization of transaction payment by a mobile device in accordance with embodiments;

FIG. 2 depicts a flowchart of a process for preauthorization of transaction payment by a mobile device in accordance with embodiments; and

FIG. 3 depicts a flowchart of a process for identifying merchant facilities based on a positional-based preauthorization request in accordance with embodiments.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “user” may be used interchangeably with the term “consumer” and/or “cardholder” and are used herein to refer to a consumer, person, individual, business or other entity that owns (or is authorized to use) a financial account such as a payment card account (for example, a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as Mastercard International Incorporated, or a similar system. In some embodiments, the term “payment card system” may be limited to systems in which member financial institutions (such as banks) issue payment card accounts to individuals, businesses and/or other entities or organizations. In addition, the term “mobile payment application” (MPA) is used interchangeably herein with the term “mobile wallet application.” Additionally, the term “wallet” is used herein interchangeably with the term “digital wallet”, wherein “wallet” may refer to the client (front-end) side or may refer to the entirety of the wallet solution, including the back-end system(s).

Often when making a purchase at shopping mall, big box store, or other establishment, customers stand in queues to have their transaction processed by the merchant. This wait can be particularly lengthy on weekends, holidays, and other periods of heavy volume. The wait can cause inconvenience or even discomfort for the customer—which at times can be substantial. Because of this waiting time, customers might chose not to visit establishments during these periods to avoid the queues. The loss of customer traffic can then translate to a financial loss for the merchant, issuer, and acquirer.

Conventionally, after a customer swipes a payment card at a POS machine there is a delay as the transaction amount is authorizes by the card issuer. After the verification and authorization is done the transaction is then completed and a transaction receipt is provided to the customer. The conventional process can take at least about one minute to complete. If the authorization is not obtained (during the transaction's first step), there is additional inconvenience for the customer.

In accordance with embodiments, preauthorization of an amount based on a customer's spending habits can be done in advance of the customer entering an establishment. This preauthorization can make the customer's transactional experience seamless and eliminate the waiting to proceed with the transaction process. In some implementations, the preauthorization can incorporate positional information obtained from a customer's mobile device. Embodying systems and processes can be integrated with Masterpass™ as a platform to enable both notifying the customer of the preauthorization, and arranging subsequent payment over the mobile device.

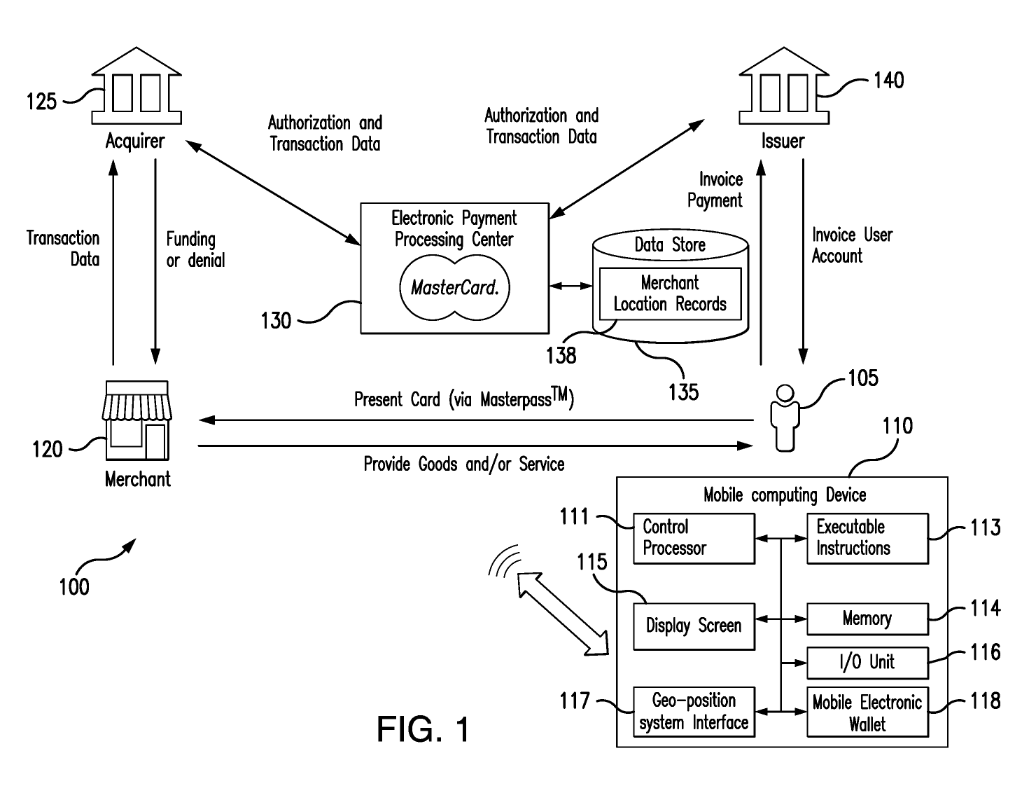

FIG. 1 depicts system 100 for preauthorization of transaction payment by a mobile device in accordance with embodiments. An embodying system can include one or more user(s) 105, each user having a mobile computing device 110.

The term “mobile computing device” refers to tablets, smart phones, wearable computing devices (watch, eyeglasses, head mounted devices, etc.), touch screen monitors, gesture-controlled devices, etc. Embodying systems and methods are not so limited to just these types of mobile computing devices. Current and/or future mobile computing device types are within the scope of this disclosure. A user of embodying systems is not limited to using just one type of mobile computing device, but can switch between devices based on any number of factors.

Each mobile computing device can include control processor 111 that communicates with other components over internal data/control bus 112. Control processor 111 accesses computer executable instructions 113, which can be stored in memory 114. Mobile computing device 110 can include display screen 115. The mobile computing device can include input/output (I/O) unit 116 that communicates wirelessly across an electronic communication network (not shown). I/O unit 116 can support one or more hardwire and/or wireless communication protocols including, but not limited to, cellular telephone protocol, Bluetooth, low energy Bluetooth, iBeacon, near field communication, Airplay, etc.

The electronic communication network can be, can comprise, or can be part of, a private internet protocol (IP) network, the Internet, an integrated services digital network (ISDN), integrated services digital network (ISDN), a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication infrastructure. It should be recognized that techniques and systems disclosed herein are not limited by the nature of the electronic communication network.

Included in the mobile communication device can be geo-position system interface 117, which is in communication with a positional sensing system (e.g., global position satellite (GPS) system, indoor positioning system, etc.). The geo-position system interface receives signals and determines the position (absolute and/or relative) of the mobile device based on the received signals. The control processor may be a processing unit, a field programmable gate array, discrete analog circuitry, digital circuitry, an application specific integrated circuit, a digital signal processor, a reduced instruction set computer processor, etc.

Mobile computing device 110 can include mobile electronic wallet application 118 (e.g., Masterpass™) to implement transactions on the mobile computing device. The mobile electronic wallet application is integrated in the mobile computing device to support contactless shopping and other features of a mobile electronic wallet.

In accordance with embodiments, merchant 120 can provide goods and/or services to user 105. The user can wirelessly present a payment card via mobile electronic wallet application 118 on the mobile computing device. The merchant reports the transaction data (amount, card identification, etc.) to acquirer bank 125.

Electronic payment processing center 130 (e.g., a Mastercard processing location) receives the transaction amount from the acquirer bank, and forwards that information to issuer bank 140. Issuer bank makes a determination on whether to authorize the transaction, and returns the result of the determination to the electronic payment processing center. The result of the authorization determination is returned from electronic payment processing center 130 to acquirer bank 125. Based on whether issuer bank 140 determined to fund or deny the transaction, the acquirer bank either funds the transaction amount (minus the merchant's discount rate and transaction fees), or notifies the merchant of the denial. Issuer bank 140 can invoice the user's account, and receive payment from the user.

In accordance with embodiments, a customer's (i.e., user) payment card can be preauthorized for a determined amount as the customer enters (or approaches) the merchant's establishment. After the customer makes a purchase selection, the customer need only present the item for purchase to have a receipt generated by the merchant. Embodying systems and processes reduces a customer interaction at the POS terminal, thus reducing the time for a customer to conduct the transaction.

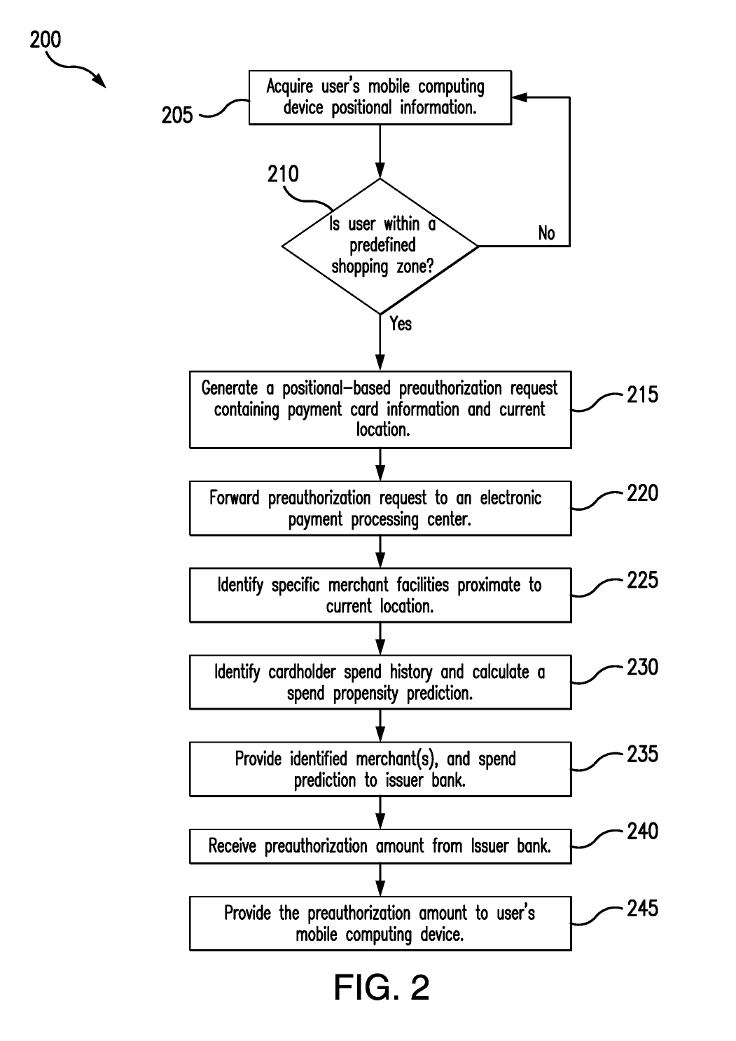

FIG. 2 depicts process 200 for preauthorization of transaction payment by a mobile device in accordance with embodiments. The positional information of a user's mobile computing device is acquired, step 205. A determination is made, step 210, as to whether the user is within a predefined shopping zone based on the positional information. The predefined shopping zone can be in proximity to a big box store entrance, a collection of establishments (e.g., shopping mall, strip mall, downtown/main street shopping district, etc.), and/or a single retail establishment. If the user's position is not proximal to a shopping zone, process 200 continues to monitor the user's positional information.

If the user's positional information is within the predefined shopping zone, then a positional-based preauthorization request is generated, step 215, at the mobile computing device. This request can contain payment card information and the positional information. The request can be generated, in some implementations, by mobile electronic wallet 118. The request is forwarded, step 220 to electronic payment processing center 130.

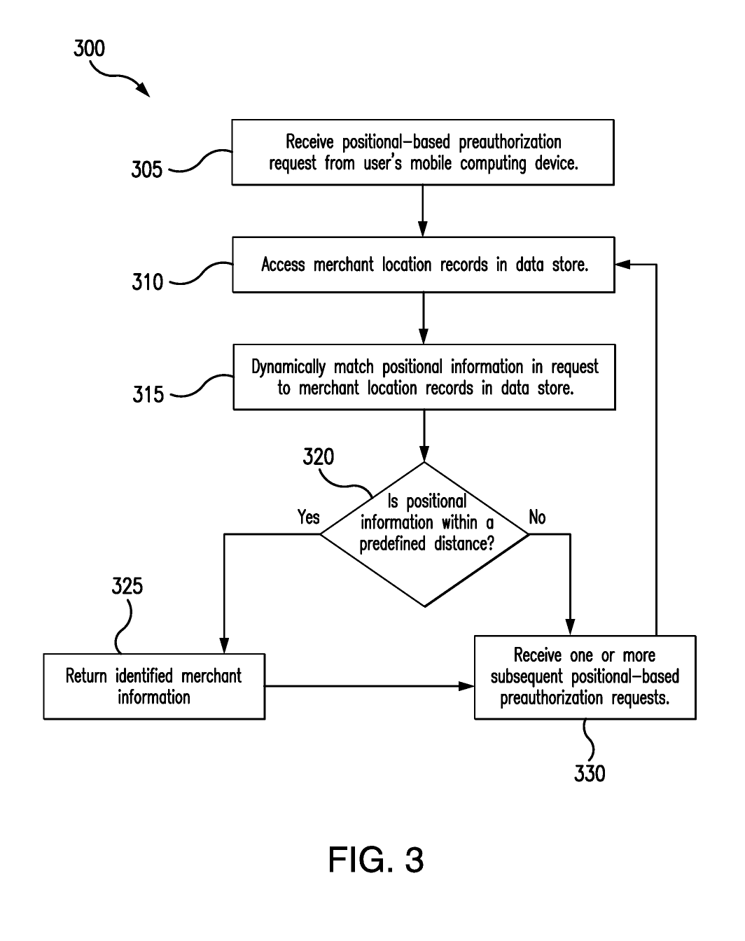

Specific merchant facilities proximate to the position information is identified, step 225. FIG. 3 depicts process 300 for identifying merchant facilities from a positional-based preauthorization request in accordance with embodiments. A positional-based preauthorization request is received, step 305, at electronic payment processing center 130 from a user's mobile computing device. Merchant location records 138 in data store 135 are accessed, step 310. The positional information within the preauthorization request is dynamically matched, step 315, to the merchant's physical location listed in the location records. A match can be identified if the positional information is within a predetermined distance from a merchant location, step 320. The identified merchant is returned, step 325, to Process 200 (step 230). Subsequent positional-based preauthorization requests can be received, step 330. Dynamic matching steps 310-320 are then repeated.

Returning to Process 200, the identified merchant(s) are provided, step 235, to the issuer bank along with a prediction of the user's spend propensity calculated by the electronic payment processing center. The issuer bank determines a preauthorization amount, which is received at the electronic payment processing center, step 240. The amount of the preauthorization can be based on the cardholder's prior spend history, and risk score. The preauthorization amount is provided to the user's mobile computing device, step 245, so that the preauthorization amount is accessible to the electronic wallet application. The preauthorization amount can be visible to the user on display screen 115 of the mobile computing device.

In accordance with embodiments, communication between the mobile computing device and the electronic payment processing location to create the preauthorization request can be across a first electronic communication network. When the user approaches the merchant's POS counter, contactless communication between the electronic wallet and the POS terminal can initiate communication between the merchant and acquirer bank on a second communication network. Thus, obtaining a preauthorization in advance of communicating with the merchant's POS terminal can reduce the bandwidth demand on the second communication network.

In accordance with embodiments, the user's location information can be obtained in real time—e.g., continuously, or updated at intervals. As the cardholder enters a shopping zone, the issuer bank is triggered for preauthorization by the electronic payment processing center. When the customer arrives at a merchant's POS counter, the transaction can be completed in less time than under conventional approaches.

In accordance with embodiments, the preauthorization amount can be reserved (i.e., blocked out) by the electronic payment processing center while the user is within a geofence defined by the predefined shopping zone and/or the predetermined distance described above. Reserving the preauthorization amount prevents access to that portion of the payment card credit. Upon exiting this geofence the reserved amount can be released from its hold by the issuer bank after the electronic payment processing center makes a determination that the user is now beyond the geofence.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform a method for preauthorization of transaction payment by a mobile computing device based on positional information, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A system for preauthorization of a transaction payment based on positional information, the system comprising:
an electronic payment processing center in communication with a mobile computing device across an electronic communication network, the mobile computing device including an electronic wallet application associated with at least one payment card account;
the electronic payment processing center including a data store containing merchant location records, the merchant location records including merchant physical location information;
the electronic payment processing center configured to:
acquire positional information of the mobile computing device;
access the merchant location records;
compare the mobile computing device positional information with the merchant location records;
identify whether at least one merchant has a physical location within a predefined distance of the mobile computing device, if at least one merchant is identified, then:
calculate a spend propensity prediction for the at least one payment card account;
provide to an issuer bank of the at least one payment card account the identified merchant and the spend propensity prediction;
receive from the issuer bank a preauthorization amount associated with a respective one of the at least one payment card account; and
provide the preauthorization amount to the mobile computing device.

2. The system of claim 1, including the electronic payment processing center configured to receive transaction data from the identified merchant, the transaction data including identification of the respective one of the at least one payment card account associated with the preauthorization amount.

3. The system of claim 1, including the electronic payment processing center configured to:
create a reserve on the payment card account equal to the preauthorization amount;
describing a geofence a perimeter based on the predefined distance and at least one merchant physical location; and
maintaining the reserve while the mobile computing device is within the geofence perimeter.

4. The system of claim 3, including the electronic payment processing center configured to inform the issuer bank when the mobile computing device is outside the geofence perimeter.

5. The system of claim 1, including the electronic payment processing center configured to acquire the mobile computing device positional information at least one of continuously or at intervals.

6. The system of claim 1, including:
the electronic payment processing center and the mobile computing device in communication across a first electronic communication network; and
a merchant point of sale terminal in communication with the electronic payment processing center across a second electronic communication network, the second electronic communication network being separate at least in part from the first electronic communication network.

7. A method of preauthorization of a transaction payment based on positional information, the method comprising:
an electronic payment processing center receiving communication from a mobile computing device across an electronic communication network, the mobile computing device including an electronic wallet application associated with at least one payment card account;
accessing by the electronic payment processing center a data store containing merchant location records, the merchant location records including merchant physical location information;
the electronic payment processing center:
acquiring positional information of the mobile computing device;
accessing the merchant location records;
comparing the mobile computing device positional information with the merchant location records;
identifying whether at least one merchant has a physical location within a predefined distance of the mobile computing device, if at least one merchant is identified, then:
calculating a spend propensity prediction for the at least one payment card account;
providing to an issuer bank of the at least one payment card account the identified merchant and the spend propensity prediction;
receiving from the issuer bank a preauthorization amount associated with a respective one of the at least one payment card account; and
providing the preauthorization amount to the mobile computing device.

8. The method of claim 7, including the electronic payment processing center receiving transaction data from the identified merchant, the transaction data including identification of the respective one of the at least one payment card account associated with the preauthorization amount.

9. The method of claim 7, including the electronic payment processing center:
creating a reserve on the payment card account equal to the preauthorization amount;
describing a geofence a perimeter based on the predefined distance and at least one merchant physical location; and
maintaining the reserve while the mobile computing device is within the geofence perimeter.

10. The method of claim 9, including the electronic payment processing center informing the issuer bank when the mobile computing device is outside the geofence perimeter.

11. The method of claim 7, including the electronic payment processing center acquiring the mobile computing device positional information at least one of continuously or at intervals.

12. The method of claim 7, including:
the electronic payment processing center and the mobile computing device in communicating across a first electronic communication network; and
a merchant point of sale terminal communicating with the electronic payment processing center across a second electronic communication network, the second electronic communication network being separate at least in part from the first electronic communication network.

13. A non-transitory computer readable medium having stored thereon instructions which when executed by a control processor cause the control processor to perform a method of preauthorization of a transaction payment based on positional information, the method comprising:
an electronic payment processing center receiving communication from a mobile computing device across an electronic communication network, the mobile computing device including an electronic wallet application associated with at least one payment card account;
accessing by the electronic payment processing center a data store containing merchant location records, the merchant location records including merchant physical location information;
the electronic payment processing center:
acquiring positional information of the mobile computing device;
accessing the merchant location records;
comparing the mobile computing device positional information with the merchant location records;
identifying whether at least one merchant has a physical location within a predefined distance of the mobile computing device, if at least one merchant is identified, then:
calculating a spend propensity prediction for the at least one payment card account;
providing to an issuer bank of the at least one payment card account the identified merchant and the spend propensity prediction;
receiving from the issuer bank a preauthorization amount associated with a respective one of the at least one payment card account; and
providing the preauthorization amount to the mobile computing device.

14. The medium of claim 13 containing computer-readable instructions stored therein to cause the electronic payment processing center to perform the method, including receiving transaction data from the identified merchant, the transaction data including identification of the respective one of the at least one payment card account associated with the preauthorization amount.

15. The medium of claim 13 containing computer-readable instructions stored therein to cause the electronic payment processing center to perform the method, including:
creating a reserve on the payment card account equal to the preauthorization amount;
describing a geofence a perimeter based on the predefined distance and at least one merchant physical location; and
maintaining the reserve while the mobile computing device is within the geofence perimeter.

16. The medium of claim 15 containing computer-readable instructions stored therein to cause the electronic payment processing center to perform the method, including informing the issuer bank when the mobile computing device is outside the geofence perimeter.

17. The medium of claim 13 containing computer-readable instructions stored therein to cause the electronic payment processing center to perform the method, including acquiring the mobile computing device positional information at least one of continuously or at intervals.

18. The medium of claim 13 containing computer-readable instructions stored therein to cause the electronic payment processing center to perform the method, including:
the electronic payment processing center and the mobile computing device in communicating across a first electronic communication network; and
a merchant point of sale terminal communicating with the electronic payment processing center across a second electronic communication network, the second electronic communication network being separate at least in part from the first electronic communication network.
